(19) United States
(12) Patent Application Publication
(10) Pub. No.: US 2024/0424708 A1
(43) Pub. Date: Dec. 26, 2024

(54) DIE-HOLDER CYLINDER FOR A SHEET MATERIAL DIE-CUTTING MACHINE

(71) Applicant: COMERCIAL INDUSTRIAL MAQUINARIA CARTON ONDULADO, S.L., Martorell, Barcelona (ES)

(72) Inventors: Ramon SERRA OBIOL, Martorell (ES); Jordi PUIG VARGAS, Martorell (ES)

(73) Assignee: COMERCIAL INDUSTRIAL MAQUINARIA CARTON ONDULADO, S.L., Martorell, Barcelona (ES)

(21) Appl. No.: 18/703,484

(22) PCT Filed: Oct. 19, 2022
(86) PCT No.: PCT/ES2022/070663

§ 371 Date: Apr. 22, 2024

(30) Foreign Application Priority Data
Oct. 22, 2021 (ES) U202132071

(51) Int. Cl. B26D 7/26

(52) U.S. Cl. CPC B26D 7/26; B26D 2007/2607

(57) ABSTRACT

The die-bearing cylinder (1) comprises a surface (3) provided with a plurality of holes (4) internally threaded, said holes (4) presenting a grid arrangement formed by a plurality of rows and lines in the coordinate axes “X” and “Y”, and engagement means consisting of a plurality of fastening assemblies (5), each of which having a retractable bolt (7) protruding from the surface of the cylinder (1) defining a geometric center and a geometric axis, wherein a central transverse plane divides the die-holding cylinder into a first half (A) and a second half (B), with the arrangement of the threaded holes (4) and the fastening assemblies (5) in the second half (B) being rotated 180°, or being symmetrical, with respect to the arrangement of the threaded holes (4) and the fastening assemblies (5) of the first half (A).

### OBJECT OF THE INVENTION

The object of this application is the registration of a die-holding cylinder for a sheet material die-cutting machine.

More specifically, the invention proposes the development of a die-holding cylinder that allows an optimization in the arrangement of holes provided for engaging dies.

### BACKGROUND OF THE INVENTION

Within the sector of rotary die-cutters for handling cardboard sheets, the use of a die-holding cylinder is known that has an engagement system for the dies that allows quick mounting and dismounting of the die on the die-holding cylinder. An example of this type of engagement system is disclosed in document ES 2155334.

Usually, die-holding cylinders have a grid of threaded holes so that the die can be fixed to the cylinder by means of screws through holes made on the die with the same distribution of threaded holes present on the die-holding cylinder. Although the arrangement of the above engagement system has a number of advantages, it should be noted that the implantation of said system in the die-holding cylinder inevitably reduces the number of threaded holes. This would not be a problem if all the dies allowed for fixing holes to be made for said system at any point on the surface of the die. On the contrary, if there is a high density of blades or other elements on the die, it is possible that not enough holes can be made for the engagement system to guarantee a good fixation of the die on the die-holding cylinder because the position of the them match with blades, splitters, extractors, etc. That is why, sometimes, it is necessary to ensure the fixing of the die on the die-holding cylinder with the use of fixing screws apart from the engagement system. A possible solution to this is to increase the number of fastening elements of the engagement system, however, it implies a weakening in terms of the mechanical resistance of the cylinder that can negatively affect the shocks that the cylinder receives during its operation, that is, during punching operations.

### DISCLOSURE OF THE INVENTION

The present invention has been developed in order to provide a die-holding cylinder that is configured as a novelty within the field of application and solves the aforementioned drawbacks, also providing other additional advantages that will be evident from the description that follows.

The die-holding cylinder according to the present invention is defined in claim 1, and additional optional features are included in the dependent claims.

It is, therefore, an object of the present invention to provide a die-holding cylinder for a die-cutting machine for laminar material, intended to be incorporated into die-cutting machines, especially designed for die-cutting cardboard sheets with subsequent use in the industry of manufacturing packages comprising a surface provided with a plurality of internally threaded holes, such holes presenting a grid arrangement formed by a plurality of rows and lines in the “X” and “Y” coordinate axes, and engagement means consisting of a plurality of fastening assemblies each having a retractable bolt protruding from the surface of the cylinder defining a geometric center, the bolts being intended to engage dies.

In addition, a central transverse plane divides the die-holding cylinder into a first half and a second half, the arrangement of the threaded holes and the fastening assemblies in the second half being rotated 180°, or being symmetrical, with respect to the arrangement of the threaded holes and the fastening assemblies of the first half. This feature allows the die to be placed in two different positions, thus facilitating its positioning for operators.

Preferably, geometric axes of the bolt of the fastening assemblies are positioned in such a way that they are individually distributed between two internally threaded holes and axially aligned on a coordinate axis “X” that passes through the two holes and at an equidistant distance between said two holes.

It should be mentioned that these threaded holes are provided to ensure the fixing of the rotary die to the die-holding cylinder by means of screw elements in the event that the engagement system described below, which is based on the use of retractable bolts, is not used.

Thanks to these characteristics, the incorporation of the engagement system eliminates the minimum number of threaded holes for fixing the die with screws.

Preferably, the central circumferential line of the die-holding cylinder body surface, corresponding to the coordinate axis “Y” in a centered position in an unfolded surface condition, provided with internally threaded holes located extending circumferentially around from the surface, it is devoid of fastening assemblies. This is due to the possibility that the center of the die has cutting means, such as blades or cleavers. For this reason, it makes it impossible to make holes in the fixing elements, so that said elements would often be rendered useless.

Preferably, the coordinate axis “X” is a longitudinal axis of the die-holding cylinder and the coordinate axis “Y” is a transverse axis of the die-holding cylinder.

Preferably, the fastening assemblies are arranged on the surface of the die-holding cylinder in a staggered pattern.

According to the invention, the fastening assembly comprises a movable bolt actuated by an actuator device, being housed inside a hollow body that is attached to the body of the die-holding cylinder.

Advantageously, each fastening assembly occupies only two threaded holes.

The described die-holding cylinder represents, therefore, an innovative structure with structural and constitutive characteristics hitherto unknown for its intended purpose, reasons that, together with its practical utility, provide it with sufficient foundation to obtain the privilege of exclusivity that is requested.

Other characteristics and advantages of the die-holding cylinder object of the present invention will be evident from the description of a preferred, but not exclusive, embodiment, which is illustrated by way of non-limiting example in the accompanying drawings, in which:

### BRIEF DESCRIPTION OF THE DRAWINGS

FIG. 1.—Is a schematic plan view of an unfolded development of a die-holding cylinder according to a first embodiment of the invention;

FIG. 2.—Is an exploded perspective view of a die-holding cylinder according to the present invention and a die designed to use the engagement means provided in the invention;

FIG. 3.—Is a perspective view of a die-holding cylinder according to the invention that has a die mounted with specific holes to be fixed with the engagement means that form part of the invention;

FIGS. 4a, 4b and 4c.—Are schematic elevation views corresponding to three portions of unfolded surfaces of die-holding cylinders, being FIGS. 4a and 4b corresponding to prior art configurations while FIG. 4c corresponds to a surface of a die-holding cylinder according to the present invention; and

FIG. 5.—Is a schematic plan view of an unfolded development of a die-holding cylinder according to a second embodiment of the invention.

### DESCRIPTION OF A PREFERRED EMBODIMENT

In view of the aforementioned figures and, in accordance with the adopted numbering, an example of a preferred embodiment of the invention can be seen in them, which comprises the parts and elements that are indicated and described in detail below.

Furthermore, the terms first, second, third, and the like in the description and claims are used to distinguish between like items and not necessarily to describe a sequential or chronological order. The terms may be interchanged in appropriate circumstances and embodiments of the invention may operate in other sequences than those described or illustrated herein.

Furthermore, the terms top, bottom, upper, lower, and the like in the description and claims are used for purposes of description and not necessarily to describe relative positions.

As shown, the die-holding cylinder, generally indicated with the reference (1), is intended to be incorporated into die-cutting machines, especially designed for die-cutting cardboard sheets with subsequent use in the industry for manufacturing packages, such as, for example, for the manufacture of cardboard boxes.

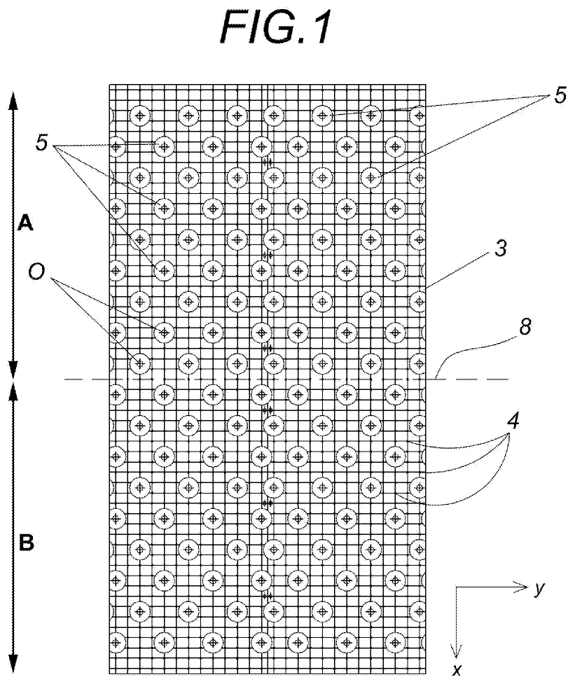

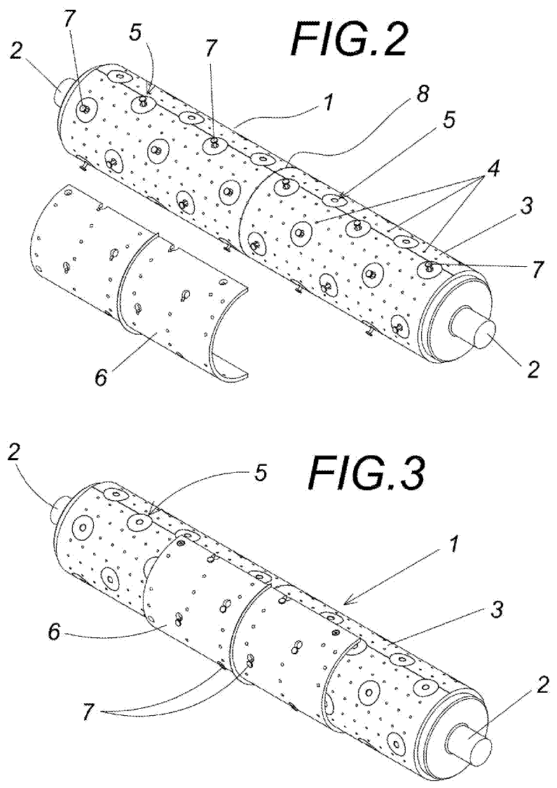

This die-holding cylinder (1) comprises a cylindrical-shaped body that has a shaft (2) at each end to be engaged to the die-cutting machine (not shown), and a surface (3) provided with a plurality of holes (4) internally threaded. As can be seen more clearly in FIG. 1, the holes (4) are arranged in a grid formed by a plurality of rows and lines in the coordinate axes “X” and “Y”, and engagement means consisting in a plurality of fastening assemblies, indicated generally with the reference (5), each of them having a retractable bolt (7) protruding from the surface of the cylinder that defines a geometric center, the bolts being intended to engage to dies (6), in particular with an arched cross-section.

According to the embodiment shown in the figures, the coordinate axis “X” is a longitudinal axis of the die-holding cylinder and the coordinate axis “Y” is a transverse axis of the die-holding cylinder.

In addition, a central transverse plane divides the die-holding cylinder into a first half (A) and a second half (B), with the arrangement of the threaded holes (4) and the fastening assemblies (5) in the second half (B) rotated 180° with respect to the arrangement of the threaded holes (4) and the fastening assemblies (5) of the first half (A), as can be seen in FIG. 1. According to this figure, the central transverse plane, seen from the die-holding cylinder in plan view, will coincide with the central circumferential line (8).

The fastening assemblies (5) are in a staggered distribution as can be seen more clearly in FIG. 1, which ensures that the bolts (7) occupy the entire surface of the die (6) in a uniform manner.

The reference point (O) (central reference point) of the geometric axes of the bolt (7) of the fastening assemblies are positioned in such a way that they are individually distributed between two holes (4) internally threaded and axially aligned on one coordinate axis “X” that crosses the two holes (4) and at an equidistant distance between said two holes (4).

It should be mentioned that the coordinate axis “Y” that corresponds to the central line (8) (indicated in FIG. 1 with broken lines and that is perpendicular to the longitudinal axis of the die-holding cylinder) provided with internally threaded holes located in which circumferentially extending around the surface are devoid of fastening assemblies (5).

Returning to the fastening assembly (5), it comprises a linearly movable mushroom-shaped bolt (7) that is actuated by means of an actuating device based on a pneumatic system (cylinder-piston), being housed inside a hollow body which is attached to the body of the die-holding cylinder (1). The operation of the fastening assembly will not go into greater detail since it is the same as that disclosed in document ES 2155334 of the same owner as the present application.

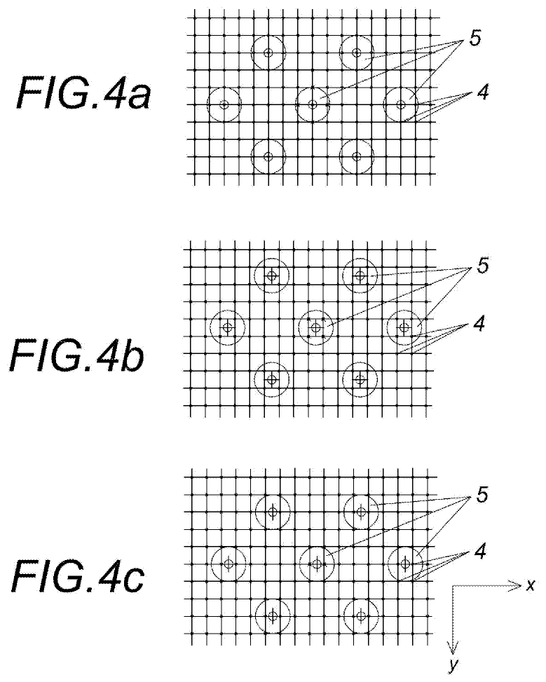

FIGS. 4a and 4b show surface configurations of a die-holding cylinder of the prior art where the number of threaded holes is notably reduced by the presence of the engagement means, as a surface that obstructs a greater number of threaded holes is required, while FIG. 4c corresponds to a surface of the die-holding cylinder according to the one shown in FIG. 1, where it can be seen how the engagement means only occupy two threaded holes. On the contrary, in the embodiments of FIGS. 4a and 4b it can be seen that the number of unused threaded holes for each fastening assembly is greater.

It can also be seen in FIG. 4c that the reference point O of each fastening assembly (5) is arranged between two adjacent threaded holes (4) aligned in the direction of the axis “X” and offset with respect to the threaded holes (4) in the direction of the axis “Y”

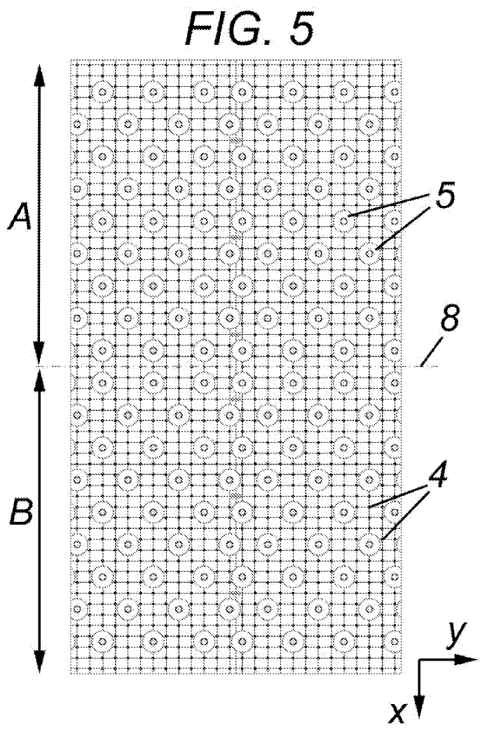

In FIG. 5 a second embodiment of the die-holding cylinder (1) according to the present invention is shown.

In this second embodiment, the only difference with respect to the previous embodiment is that the arrangement of the threaded holes (4) and the fastening assemblies (5) in the second half (B) is symmetrical with respect to the arrangement of the threaded holes (4) and the fastening assemblies (5) of the first half (A).

The details, shapes, dimensions and other accessory elements used in the manufacture of the die-holding cylinder of the invention may be conveniently replaced by others that do not deviate from the scope defined by the claims included below.

What is claimed is:

1. Die-holding cylinder (1) for a sheet material die-cutting machine, comprising:
a surface (3) provided with a plurality of internally threaded holes (4), such holes (4) presenting a grid layout formed by a plurality of rows and lines in the coordinate axes “X” and “Y”, and
engagement means consisting of a plurality of fastening assemblies (5), each of which having a retractable bolt (7) protruding from the surface of the cylinder (1) defining a geometric center and a geometric axis, the bolts (7) being intended to be attached to dies, characterized in that
a central transverse plane divides the die-holding cylinder into a first half (A) and a second half (B), the arrangement of the threaded holes (4) and the fastening assemblies (5) in the second half (B) being rotated 180°, or being symmetrical, with respect to the arrangement of the threaded holes (4) and the fastening assemblies (5) of the first half (A).

2. Die-holding cylinder (1) according to claim 1, wherein the geometric axes of the bolt (7) of the fastening assemblies (5) are positioned in such a way that they are individually distributed between two internally threaded holes (4) and axially aligned on a coordinate axis “X” that passes through the two holes and at an equidistant distance between said two holes (4).

3. Die-holding cylinder (1) according to claim 1, wherein a central circumferential line (8) of the surface of the body of the die-holding cylinder (1), corresponding to the coordinate axis “Y” in a position centered on a condition of the unfolded surface, provided with internally threaded holes (4) located extending circumferentially around the surface, is devoid of fastening assemblies (5).

4. Die-holding cylinder (1) according to claim 1, wherein the coordinate axis “X” is a longitudinal axis of the die-holding cylinder.

5. Die-holding cylinder (1) according to claim 1, wherein the coordinate axis “Y” is a transverse axis of the die-holding cylinder.

6. Die-holding cylinder (1) according to claim 1, wherein the fastening assemblies (5) are in a staggered distribution.

7. Die-holding cylinder (1) according to claim 1, wherein the fastening assembly (5) comprises a movable bolt (7) actuated by an actuator device, being housed inside a hollow body that is attached to the body of the die-holding cylinder (1).

8. Die-holding cylinder (1) according to claim 1, wherein each fastening assembly (5) occupies only two threaded holes (4).
